(19) United States
(12) Patent Application Publication
(10) Pub. No.: US 2008/0266267 A1
(43) Pub. Date: Oct. 30, 2008

(54) Pen for touch pad of a laptop

(76) Inventor: Chih-Chang Chang, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/790,922

(22) Filed: Apr. 30, 2007

(51) Int. Cl. G06F 3/041

(52) U.S. Cl. 345/173

(57) ABSTRACT

A pen for the touch pad of a laptop includes a conductive penholder, wherein a conductive pen head is installed on one end of the conductive penholder, and a smooth layer is located on the surface of the conductive pen head. The conductive pen can deliver the static electricity from a human's body through the conductive pen to the touch pad of a laptop computer. It replaces the original operation in which a user uses their finger to touch the touch pad of the laptop. It is convenient for the user and the user can operate it for a long time. The problems caused by the user's sweat re avoided. The opposite end of the conductive penholder can be installed with a PDA pen, a ball-point pen, a laser, or a pencil. The function of the present invention is therefore versatile.

### BACKGROUND OF THE INVENTION

1. Field of the Invention

The present invention relates to a pen for the touch pad of a laptop. In particular, this invention relates to a touch pen that can be held by the user and deliver the user's static electricity from his or her body to the touch pad of a laptop. The problem caused by sweat from the user's fingers and aches caused by using the touch pad for a long time are thereby avoided.

2. Description of the Related Art

As laptops have developed, people have come to carry their laptop around with them so that they can use it anywhere, anytime. The laptop usually uses a mouse. Except for that, the user also can use the touch pad to interact with the laptop.

Reference is made to FIG. 1, which shows a schematic diagram of the usage status of the touch pad 41′ of the laptop 40′. The user uses his or her finger to touch the touch pad 41′. The touch pad 41′ senses the finger's displacement and the clicking action by the resistance generated from the finger to make the cursor move and execute the clicking action. Thereby, the laptop executes corresponding commands.

However, by using their fingers to touch the touch pad of the laptop, the problem caused by the user's sweat often occurs, and the user feels uncomfortable after using the touch pad for a long time.

For other devices with a touch pad, such as PDAs, the difference between the touch pad of the PDA and the touch pad of the laptop is that the touch pad of the PDA merely needs to be touched by a pen with a tiny object at the tip of the pen. The touch pad of the laptop meanwhile needs to be touched by a conductive object, such as a finger, and the touched area must be larger than one square centimeter. Therefore, a touch pen for a PDA cannot be used for the touch pad of a laptop.

### SUMMARY OF THE INVENTION

One particular aspect of the present invention is to provide a pen for the touch pad of a laptop. The pen can conduct static electricity. The pen can be held by the user and conduct static electricity from a human body's to the touch pad of the laptop. The operating method of using the user's finger to directly touch the touch pad of the laptop is replaced. The problem of aches caused by touching the touch pad by finger for a long time is avoided, and problems caused by the user's sweat are also overcome.

The pen for the touch pad of a laptop includes a conductive penholder, a conductive pen head installed on one end of the conductive penholder, and a smooth layer located on the surface of the conductive pen head and wrapping around part of the conductive pen head.

The present invention has the following characteristics. The conductive penholder and the conductive pen head can conduct a human body's static electricity to the laptop to improve upon the problem caused by the user's sweat and lower the problem of aches caused by directly touching the touch pad for a long time. The conductive pen head is designed according to the contours of a human's finger, and there is a smooth layer on the surface of the conductive pen head. It is smooth while the user uses the pen to touch the touch pad.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the usage status of the touch pad of the laptop of the prior art;

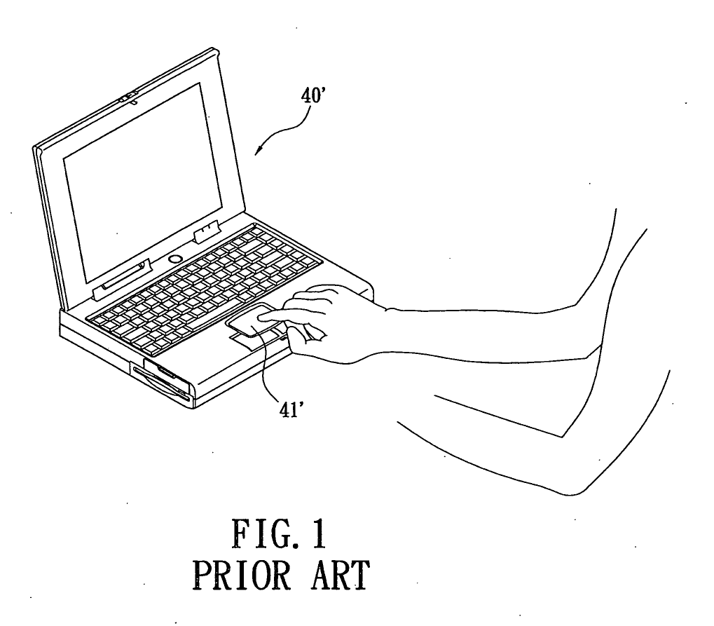

FIG. 2 is an exploded perspective view of the present invention;

FIG. 3 is a schematic diagram of the usage status of the present invention; and

FIG. 4 is a side view of the usage status of the present invention.

### DETAILED DESCRIPTION OF THE PREFERRED EMBODIMENTS

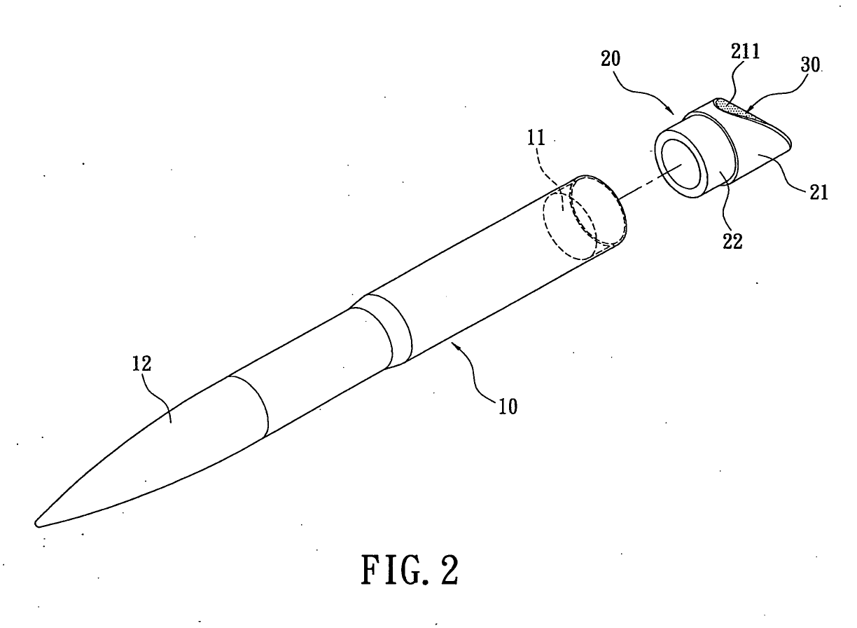

Reference is made to FIG. 2. The pen for a touch pad of a laptop computer includes a conductive penholder 10, a conductive pen head 20, and a smooth layer 30.

The conductive penholder 10 is a circular rod, and is made of conductive metal or conductive plastic. One end of the conductive penholder 10 has an opening 11.

The conductive pen head 20 is hollow and soft, and is made of conductive rubber, conductive silica gel, or conductive carbon fiber brush. The conductive pen head 20 includes a body 21, and a plugging portion 22. The plugging portion 22 is ring-shaped, and extends from one surrounding edge of the body 21. The body 21 of the conductive pen head 20 has a curved surface 211. The curved surface 211 is a cross-sectional surface that is designed to be at a 45 degree angle with the body 21 so that the outline of the conductive pen head 20 is similar to a human finger tip.

The smooth layer 30 is made of PE plastic. It is a film, and is located on the surface of the curved surface 211 of the conductive pen head 20 and wraps around part of the conductive pen head 20.

The plugging portion 22 of the conductive pen head 20 is plugged into the conductive penholder 10 via the opening 11 of the conductive penholder 10, and is combined with the conductive penholder 10.

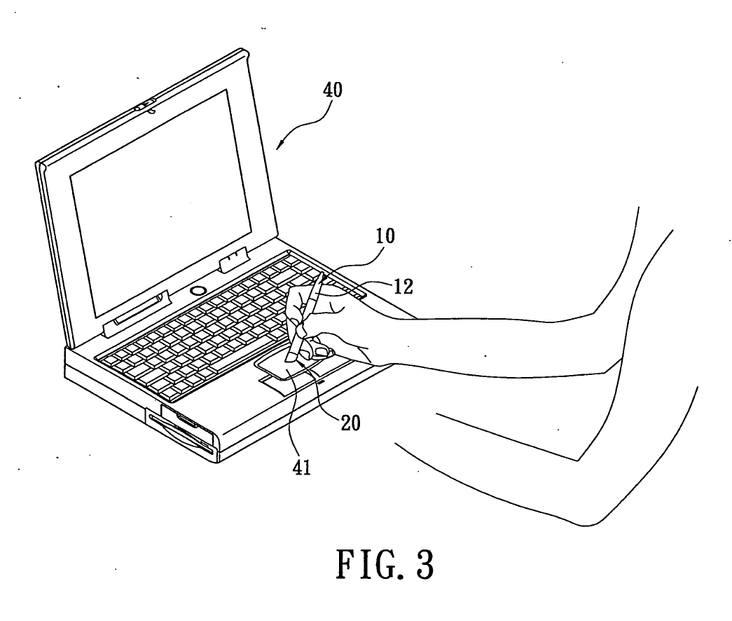

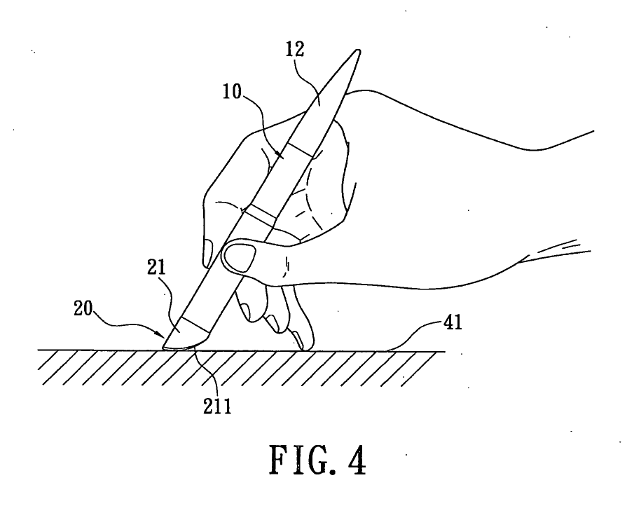

Reference is made to FIGS. 3 and 4. When the user holds the conductive penholder 10, the human body's static electricity passes through the conductive penholder 10 and is delivered to the conductive pen head 20 from the user's hand so that the conductive pen head 20 becomes an electrical conductor. The user holds the conductive penholder 10 and uses the conductive pen head 20 to touch the touch pad 41 of the laptop 40 for operating the cursor to make the cursor move and execute a clicking operation to execute corresponding commands. The smooth layer 30 located on the surface of the curved surface 211 of the conductive pen head 20 can lower the friction coefficient of the curved surface 211 of the conductive pen head 20. The experience will feel smooth to the user when using the pen to touch the touch pad.

The second end of the conductive penholder 10 that is opposite to the conductive pen head 20 has a PDA pen 12. Therefore, the pen of the present invention can be used for both the touch pad 41 of the laptop 40 and a PDA. Alternatively, the second end of the conductive penholder 10 that is opposite to the conductive pen head 20 also can be installed with a ball-point pen, a laser, or a pencil.

The present invention has the following characteristics:

1. The conductive penholder 10 and the conductive pen head 20 of the present invention can conduct the static electricity of a human's body to the touch pad 41 of the laptop 40. Thereby, the user can use the present invention to drive the cursor of the laptop 40 and execute commands. It lowers the problem of aches caused by directly touching the touch pad 41 of the laptop 40 by finger for a long time and avoids the problems caused by the user's sweat.

2. The conductive pen head 20 of the present invention is soft and is similar to the outline of a human's finger. The user feels comfortable when the user uses the pen to touch the touch pad 41 of the laptop 40.

3. The smooth layer 30 of the present invention is made of PE plastic. It is a film and covers the curved surface of the conductive pen head 20 to lower the friction coefficient of the conductive pen head 20. Using the pen to touch the touch pad will feel smooth to the user.

4. The second end of the conductive penholder 10 that is opposite to the conductive pen head 20 can be installed with a PDA pen, a ball-point pen, a laser, or a pencil. The function of the present invention is therefore versatile.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A pen for a touch pad of a laptop, comprising:
a conductive penholder;
a conductive pen head installed on one end of the conductive penholder; and
a smooth layer located on a surface of the conductive pen head and wrapping around part of the conductive pen head.

2. The pen for a touch pad of a laptop as claimed in claim 1, wherein the conductive pen head has a soft piece, the conductive pen head has a curved surface, and the smooth layer is located on the curved surface.

3. The pen for a touch pad of a laptop as claimed in claim 1, wherein the conductive pen head is a piece of conductive rubber.

4. The pen for a touch pad of a laptop as claimed in claim 1, wherein the conductive pen head is a piece of conductive silica gel.

5. The pen for a touch pad of a laptop as claimed in claim 1, wherein the conductive pen head is a conductive carbon fiber brush.

6. The pen for a touch pad of a laptop as claimed in claim 1, wherein the smooth layer is a piece of plastic.

7. The pen for a touch pad of a laptop as claimed in claim 1, wherein an opposite end of the conductive penholder has a PDA pen.

8. The pen for a touch pad of a laptop as claimed in claim 1, wherein an opposite end of the conductive penholder has a laser.

9. The pen for a touch pad of a laptop as claimed in claim 1, wherein an opposite end of the conductive penholder has a ball-point pen.

10. The pen for a touch pad of a laptop as claimed in claim 1, wherein an opposite end of the conductive penholder has a pencil.
